(19) United States
(12) Patent Application Publication
(10) Pub. No.: US 2025/0089906 A1
(43) Pub. Date: Mar. 20, 2025

(54) INFLATABLE MATRESS FOR USE IN A VEHICLE

(71) Applicant: Pittman Products International, Inc., Placentia, CA (US)

(72) Inventor: James J. Pittman, Yorba Linda, CA (US)

(73) Assignee: Pittman Products International, Inc., Placentia, CA (US)

(21) Appl. No.: 18/919,761

(22) Filed: Oct. 18, 2024

Related U.S. Application Data
(63) Continuation-in-part of application No. 18/369,595, filed on Sep. 18, 2023.

(51) Int. Cl. A47C 27/08; A47C 27/10; B60N 3/00

(52) U.S. Cl. CPC A47C 27/082; A47C 27/087; A47C 27/10; B60N 3/008

(57) ABSTRACT

An inflatable mattress for use in a vehicle is disclosed and claimed. The inflatable mattress may include a removable air pump, and a first longitudinal chamber that may include a pump cavity that receives and stores the removable air pump. The pump cavity may include a first inlet that is adapted to mate with an outlet of the removable air pump within the cavity for ready inflation of the first longitudinal chamber without removal of the air pump from the cavity. The inflatable mattress may further include a second independently-inflatable longitudinal chamber having a second inlet for mating with the outlet of the removable air pump at a second inlet location that is disposed outside of the cavity.

### CROSS REFERENCES AND PRIORITIES

This application claims priority from U.S. application Ser. No. 18/369,595 filed on 18 Sep. 2023, the teachings of which are incorporated by reference herein in their entirety.

### BACKGROUND

Inflatable mattresses have been used in houses, tents, campers, RVs, truck beds, vans, and other vehicles. Some such inflatable mattresses are sized to accommodate two adults, and such mattresses can unnecessarily occupy excessive space in some vehicles with a single traveler. Certain inflatable mattresses that have more than one separate internal chamber may be inconvenient or excessively time consuming to inflate. Certain vehicles may have not have flat cargo spaces that can evenly support an air mattress, leading to sleep discomfort. Some inflatable mattress products may be unprofitable because of unnecessary complexity that adversely affects manufacturability and cost. Thus, there is a need in the art for an improved mattress design for use in vehicles.

### SUMMARY

Disclosed herein is an inflatable mattress for use in a vehicle. The inflatable mattress includes a first longitudinal chamber having a first chamber aft section, a first chamber forward section, and at least a first inlet. The first chamber aft section having a plurality of first collapsible columns with each first collapsible column of the plurality of first collapsible columns being located between and connected to a first aft section lower wall and a first aft section upper wall. The first chamber forward section is connected to the first chamber aft section by a first flexible longitudinal seam and includes a plurality of second collapsible columns with each second collapsible column of the plurality of second collapsible columns being located between and connected to a first forward section lower wall and a first forward section upper wall. The at least a first inlet being disposed in a first aft section wall.

In some embodiments, the first flexible longitudinal seam includes a fluid connection between the first chamber aft section and the first chamber forward section.

In certain embodiments, the inflatable mattress may further include a second inlet disposed in a first forward section wall.

In some embodiments, the first chamber aft section may include a pump cavity. When present, the pump cavity may be configured to receive and store a removable air pump with he first inlet located within the pump cavity.

In certain embodiments, the first aft section lower wall and the first aft section upper wall may each independently include a first layer of material, a second layer of material, and a coating. The first layer of material may be a polymer material selected from the group consisting of polyvinyl chloride (PVC) and urethane film. The second layer of material may be a fabric material selected from the group consisting of polyester, wool, and cotton. The coating may be selected from the group consisting of a waterproofing, an ultraviolet protection coating, and combinations thereof.

In some embodiments, the first chamber aft section may include a first aft sidewall extending between the first aft section lower wall and the first aft section upper wall.

In certain embodiments, the first forward section lower wall and the first forward section upper wall may each independently include a first layer of material, a second layer of material, and a coating. The first layer of material may be a polymer material selected from the group consisting of polyvinyl chloride (PVC) and urethane film. The second layer of material may be a fabric material selected from the group consisting of polyester, wool, and cotton. The coating may be selected from the group consisting of a waterproofing, an ultraviolet protection coating, and combinations thereof.

In some embodiments, the first chamber forward section may include a first forward sidewall extending between the first forward section lower wall and the first forward section upper wall.

In certain embodiments, the inflatable mattress may also include a second longitudinal chamber. When present, the second longitudinal chamber may include a second chamber aft section, a second chamber forward section, and at least a third inlet. The second chamber aft section may include a plurality of third collapsible columns with each third collapsible column of the plurality of third collapsible columns being located between and connected to a second aft section lower wall and a second aft section upper wall. When present, the second chamber forward section may be connected to the second chamber aft section by a second flexible longitudinal seam. The second chamber forward section may have a plurality of fourth collapsible columns with each fourth collapsible column of the plurality of fourth collapsible columns being located between and connected to a second forward section lower wall and a second forward section upper wall. The at least a third inlet may disposed in a second aft section wall. When the second longitudinal chamber is present, the first chamber aft section may be connected to the second chamber aft section by a third flexible seam, and the first chamber forward section may be connected to the second chamber forward section by a fourth flexible seam.

In some embodiments, the second flexible longitudinal seam may include a fluid connection between the second chamber aft section and the second chamber forward section.

In certain embodiments, the inflatable mattress may include a fourth inlet disposed in a second forward section wall.

In some embodiments, the second aft section lower wall and the second aft section upper wall may each independently include a first layer of material, a second layer of material, and a coating. The first layer of material may be a polymer material selected from the group consisting of polyvinyl chloride (PVC) and urethane film. The second layer of material may be a fabric material selected from the group consisting of polyester, wool, and cotton. The coating may be selected from the group consisting of a waterproofing, an ultraviolet protection coating, and combinations thereof.

In certain embodiments, the second chamber aft section may include a second aft section sidewall extending between the second aft section lower wall and the second aft section upper wall.

In some embodiments, the second forward section lower wall and the second forward section upper wall may each independently include a first layer of material, a second layer of material, and a coating. The first layer of material may be a polymer material selected from the group consisting of polyvinyl chloride (PVC) and urethane film. The second layer of material may be a fabric material selected from the group consisting of polyester, wool, and cotton. The coating may be selected from the group consisting of a waterproofing, an ultraviolet protection coating, and combinations thereof.

In certain embodiments, the second chamber forward section may include a second forward section sidewall extending between the second forward section lower wall and the second forward section upper wall.

In some embodiments, the inflatable mattress may include a first understep and a second understep. When present, the first understep may laterally traverse a first underside of the first longitudinal chamber between the first chamber aft section and the first chamber forward section. A first thickness of the first chamber aft section may be greater than a second thickness of the first chamber forward thickness. When present, the second understep may laterally traverse a second underside of the second longitudinal chamber between the second chamber aft section and the second chamber forward section. A third thickness of the second chamber aft section may be greater than a fourth thickness of the second chamber forward section.

### BRIEF DESCRIPTION OF FIGURES

FIG. 1 is a perspective view of an exemplary embodiment of an inflatable mattress positioned within the rear interior space of a vehicle.

FIG. 2 is a perspective view of an exemplary embodiment of an inflatable mattress positioned within the rear interior space of a vehicle.

FIG. 3 is a perspective view of an exemplary embodiment of an inflatable mattress.

FIG. 4A is a perspective view of an exemplary embodiment of an inflatable mattress.

FIG. 4B is an underside view of a leading corner region of an exemplary embodiment of an inflatable mattress.

FIG. 5 is a perspective view of a front section of an exemplary embodiment of an inflatable mattress positioned within the rear interior space of a vehicle.

FIG. 6 is a perspective view of a side section of an exemplary embodiment of an inflatable mattress positioned within the rear interior space of a vehicle.

FIG. 7 is a perspective view of a pair of forward supports for an exemplary embodiment of an inflatable mattress positioned within the interior space of a vehicle.

FIG. 8 is a perspective view of an exemplary embodiment of a removable air pump within a pump cavity in an exemplary embodiment of an inflatable mattress.

FIG. 9 is a perspective view of an exemplary embodiment of a pump cavity in an exemplary embodiment of an inflatable mattress.

FIG. 10A is a perspective view of an aft face of an exemplary embodiment of a removable air pump.

FIG. 10B is a perspective view of an insertable end of an exemplary embodiment of a removable air pump.

FIG. 11 is a perspective view of an exemplary embodiment of a removable air pump being inserted into a pump cavity in an exemplary embodiment of an inflatable mattress.

FIG. 12 is a partial cut-away view of an exemplary embodiment of an inflatable mattress.

FIG. 13 is a cross section view of a wall of an inflatable mattress.

### DETAILED DESCRIPTION

Disclosed herein are various embodiments of an inflatable mattress. The inflatable mattress is described below with reference to the Figures. As described herein, the following numbers refer to the following structures as noted in the Figures.
100 refers to an inflatable mattress.
110 refers to a first longitudinal chamber.
111 refers to a first chamber aft section.
112 refers to a first collapsible column.
113 refers to a first aft section lower wall.
114 refers to a first aft section upper wall.
115 refers to a first chamber forward section.
116 refers to a first flexible longitudinal seam.
117 refers to a second collapsible column.
118 refers to a first forward section lower wall.
119 refers to a first forward section upper wall.
120 refers to a second longitudinal chamber.
121 refers to a second chamber aft section.
122 refers to a third collapsible column.
123 refers to a second aft section lower wall.
124 refers to a second aft section upper wall.
125 refers to a second chamber forward section.
126 refers to a second flexible longitudinal seam.
127 refers to a fourth collapsible column.
128 refers to a second forward section lower wall.
129 refers to a second forward section upper wall.
130 refers to a first understep.
131 refers to a first thickness.
132 refers to a second thickness.
140 refers to a second understep.
141 refers to a third thickness.
142 refers to a fourth thickness.
150 refers to a pump cavity.
155 refers to a cavity door.
160 refers to a third flexible longitudinal seam.
165 refers to a longitudinal zipper.
167 refers to a top cover.
200 refers to a first inlet.
202 refers to a second inlet.
203 refers to a third inlet.
204 refers to a fourth inlet.
205 refers to an auxiliary inlet.
300 refers to a removable air pump.
301 refers to an aft face.
302 refers to an insertable end.
303 refers to a pumping control switch.
304 refers to a charging port.
305 refers to a pump outlet.
306 refers to a pump inlet.
307 refers to a removable nozzle attachment.
310 refers to an air pump ejection button.
410 refers to a first inflatable forward support.
420 refers to a second inflatable forward support.
430 refers to an underside stiffened region.
432 refers to a stiffening insert.
434 refers to a sewn fabric pocket.
501 refers to a first layer of material.
502 refers to a second layer of material.
503 refers to a coating.

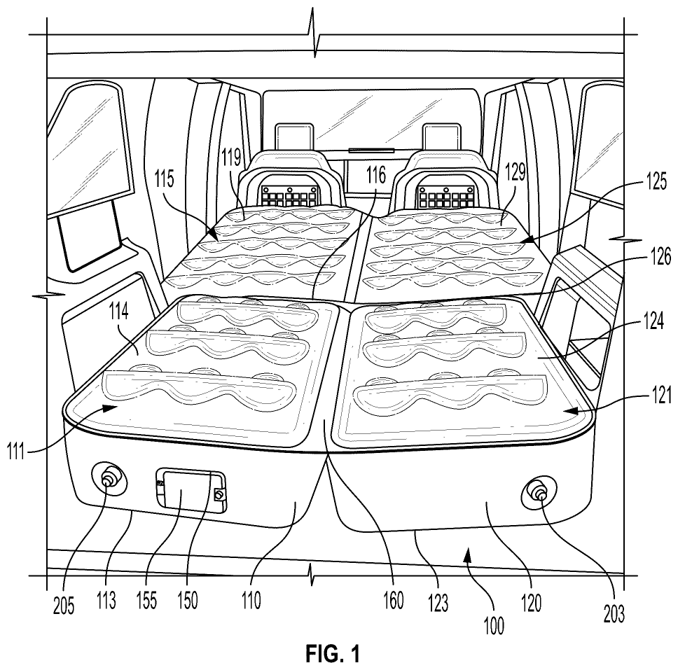

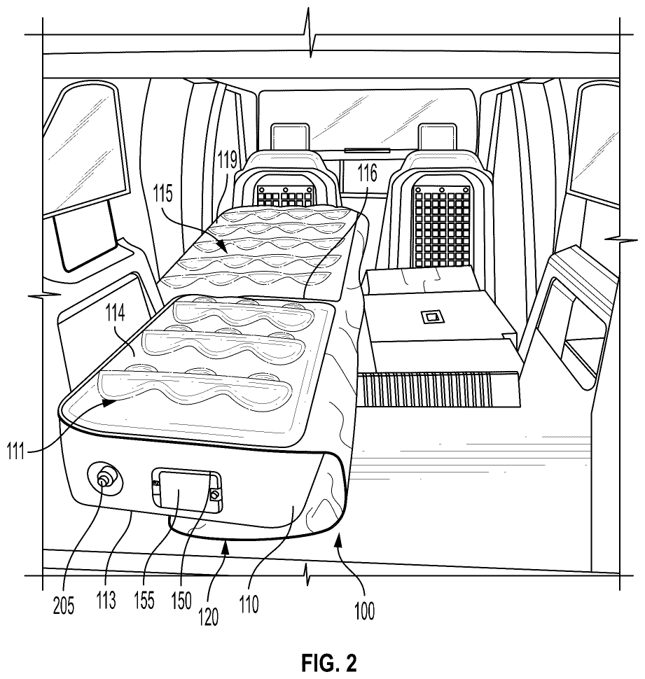

FIG. 1 depicts an inflatable mattress (100) according to an exemplary embodiment of the present invention, shown as positioned within the rear interior space of a vehicle for usage context. The vehicle shown is optionally but not necessarily a sport utility vehicle. For convenience, the term “sport utility vehicle” as used herein also includes so-called “crossover” vehicles, station wagons, and other vehicles having similar interior spaces. It is also contemplated herein that a mattress according to an exemplary embodiment of the present invention may also be used in other types of vehicles, e.g. vans, trucks, RVs, campers, etc. Regardless, the claims of this patent application are directed to an inflatable mattress and its components as specified in the claims, and do not cover any vehicle for which the inflatable mattress may be designed for use, or any vehicle, house, or tent in which an inflatable mattress may ultimately be used. FIG. 2 depicts an exemplary embodiment of the inflatable mattress (100) with a second longitudinal chamber (120) optionally left deflated.

Now referring to FIGS. 1 and 2, the inflatable mattress (100) includes a first longitudinal chamber (110) that includes a pump cavity (150) that receives and stores a removable air pump (obscured by cavity door (155) in the views of FIGS. 1 and 2) at the aft end of the inflatable mattress (100). While the Figures illustrate the pump cavity in the aft end of the first longitudinal chamber, other embodiments may exist where the pump cavity is in the forward end of the first longitudinal chamber, along a sidewall of the first longitudinal chamber, or within a top or bottom wall of the first longitudinal chamber. The removable air pump is operable to inflate the first longitudinal chamber (110) in place, without being removed, through a first inlet (also obscured in the views of FIGS. 1 and 2). The term “inlet” as used herein corresponds to a port that can be used as an inlet for inflation, but does not exclude ports that can also be used as outlets for deflation.

As shown in FIGS. 1 and 2, the first longitudinal chamber (110) may include two sections—a first chamber aft section (111) and a first chamber forward section (115). The first chamber forward section being connected to the first chamber aft section by a first flexible longitudinal seam (116) which may comprise a fabric bridge (e.g., rip-stop nylon, canvass, etc.) that may optionally, but not necessarily, be the same material as that which covers the top surface of the first chamber aft section and/or the first chamber forward section. In some embodiments, the first flexible longitudinal seam may include a fluid connection between the first chamber aft section and the first chamber forward section allowing air to flow between the first chamber aft section and the first chamber forward section such that the two sections may be inflated via a single inlet in either the first chamber aft section or the first chamber forward section. Alternatively, each of the first chamber aft section and the first chamber forward section may include an inlet with the first chamber aft section having a first inlet (200) and the first chamber forward section having a second inlet (202) such that the two sections are inflated separately from one another.

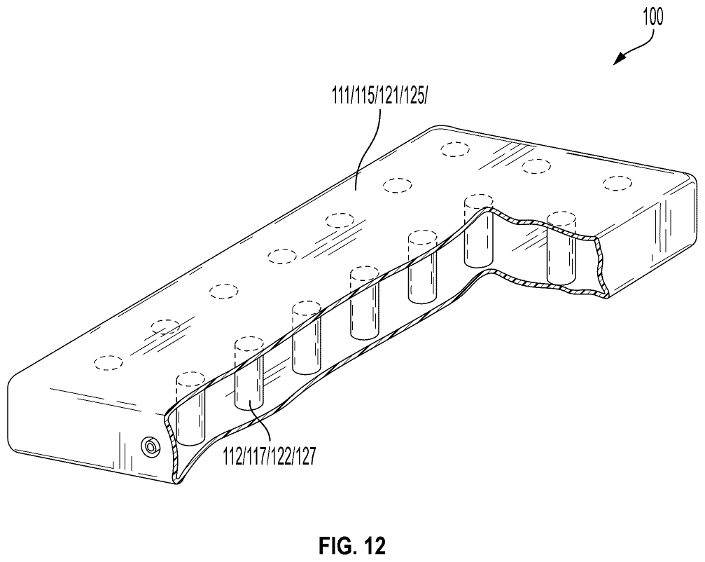

The first chamber aft section (111) may include a plurality of first collapsible columns (112) as shown in FIG. 12. When present, each collapsible column of the plurality of first collapsible columns may be located between and connected to a first aft section lower wall (113) and a first aft section upper wall (114). Each first collapsible column will have an upper end and a lower end with the upper end being sealed to an inner surface of the first aft section upper wall and the lower end being sealed to an inner surface of the first aft section lower wall.

When present, the first collapsible columns (112) may be in the form of covered springs, air cylinders, inflatable cylinders, plastic coils, or other suitable deformable supports. Horizontally-oriented surface rings may be formed where the first collapsible columns are sealed to the first aft section upper wall (114) and/or the first aft section lower wall (113) respectively.

In some embodiments, the first collapsible columns (112) may be in the form of vertically-oriented collapsible interior loops. Each interior loop may be constructed of the same or similar material as the first aft section lower wall (113) and/or the first aft section upper wall (114). As with other embodiments of the first collapsible columns, horizontally-oriented surface rings may be formed where the first collapsible columns are sealed to the first aft section lower wall and/or the first aft section upper wall respectively.

The first chamber forward section (115) may include a plurality of second collapsible columns (117) as shown in FIG. 12. When present, each collapsible column of the plurality of second collapsible columns may be located between and connected to a first forward section lower wall (118) and a first forward section upper wall (119). Each second collapsible column will have an upper end and a lower end with the upper end being sealed to an inner surface of the first forward section upper wall and the lower end being sealed to an inner surface of the first forward section lower wall.

When present, the second collapsible columns (117) may be in the form of covered springs, air cylinders, inflatable cylinders, plastic coils, or other suitable deformable supports. Horizontally-oriented surface rings may be formed where the second collapsible columns are sealed to the first forward section upper wall (119) and/or the first forward section lower wall (118) respectively.

In some embodiments, the second collapsible columns (117) may be in the form of vertically-oriented collapsible interior loops. Each interior loop may be constructed of the same or similar material as the first forward section lower wall (118) and/or the first forward section upper wall (119). As with other embodiments of the second collapsible columns, horizontally-oriented surface rings may be formed where the second collapsible columns are sealed to the first forward section lower wall and/or the first forward section upper wall respectively.

The inflatable mattress (100) may include a second longitudinal chamber (120) that is independently inflatable or deflatable via a third inlet (203) in the aft end of the inflatable mattress. While the Figures illustrate the third inlet in the aft end of the second longitudinal chamber, other embodiments may exist where the third inlet is in the forward end of the second longitudinal chamber, along a sidewall of the second longitudinal chamber, or within a top or bottom wall of the second longitudinal chamber. The third inlet is disposed outside of the pump cavity (150), and is configured to mate with the removable air pump outside of the pump cavity for optional inflation (if the user chooses to optionally utilize the second longitudinal chamber).

As further shown in FIGS. 1 and 2, the second longitudinal chamber (120) may include two sections-a second chamber aft section (121) and a second chamber forward section (125). The second chamber forward section being connected to the second chamber aft section by a second flexible longitudinal seam (126) which may comprise a fabric bridge (e.g., rip-stop nylon, canvass, etc.) that may optionally, but not necessarily, be the same material as that which covers the top surface of the second chamber aft section and/or the second chamber forward section. In some embodiments, the second flexible longitudinal seam may include a fluid connection between the second chamber aft section and the second chamber forward section allowing air to flow between the second chamber aft section and the second chamber forward section such that the two sections may be inflated via a single inlet in either the second chamber aft section or the second chamber forward section. Alternatively, each of the second chamber aft section and the second chamber forward section may include an inlet with the second chamber aft section having a third inlet (203) and the second chamber forward section having a fourth inlet (204) such that the two sections are inflated separately from one another.

The second chamber aft section (121) may include a plurality of third collapsible columns (122) as shown in FIG. 12. When present, each collapsible column of the plurality of third collapsible columns may be located between and connected to a second aft section lower wall (123) and a second aft section upper wall (124). Each third collapsible column will have an upper end and a lower end with the upper end being sealed to an inner surface of the second aft section upper wall and the lower end being sealed to an inner surface of the second aft section lower wall.

When present, the third collapsible columns (122) may be in the form of covered springs, air cylinders, inflatable cylinders, plastic coils, or other suitable deformable supports. Horizontally-oriented surface rings may be formed where the third collapsible columns are sealed to the second aft section upper wall (124) and/or the second aft section lower wall (123) respectively.

In some embodiments, the third collapsible columns (122) may be in the form of vertically-oriented collapsible interior loops. Each interior loop may be constructed of the same or similar material as the second aft section lower wall (123) and/or the second aft section upper wall (124). As with other embodiments of the third collapsible columns, horizontally-oriented surface rings may be formed where the third collapsible columns are sealed to the second aft section lower wall and/or the second aft section upper wall respectively.

The second chamber forward section (125) may include a plurality of fourth collapsible columns (127) as shown in FIG. 12. When present, each collapsible column of the plurality of fourth collapsible columns may be located between and connected to a second forward section lower wall (128) and a second forward section upper wall (129). Each fourth collapsible column will have an upper end and a lower end with the upper end being sealed to an inner surface of the second forward section upper wall and the lower end being sealed to an inner surface of the second forward section lower wall.

When present, the fourth collapsible columns (127) may be in the form of covered springs, air cylinders, inflatable cylinders, plastic coils, or other suitable deformable supports. Horizontally-oriented surface rings may be formed where the fourth collapsible columns are sealed to the second forward section upper wall (129) and/or the second forward section lower wall (128) respectively.

In some embodiments, the fourth collapsible columns (127) may be in the form of vertically-oriented collapsible interior loops. Each interior loop may be constructed of the same or similar material as the second forward section lower wall (128) and/or the second forward section upper wall (129). As with other embodiments of the fourth collapsible columns, horizontally-oriented surface rings may be formed where the fourth collapsible columns are sealed to the second forward section lower wall and/or the second forward section upper wall respectively.

In the embodiment of FIGS. 1 and 2, the first longitudinal chamber (110) optionally further comprises an auxiliary inlet (205) to provide the option for inflating and deflating the first longitudinal chamber without use of the removable air pump within the pump cavity (150). Although the pump cavity and the auxiliar inlet are preferably disposed at the aft end of the inflatable mattress (100) in this exemplary embodiment, it is contemplated that they could instead optionally be located on other sides or faces of the inflatable mattress.

In the exemplary embodiment of FIG. 1, the first longitudinal chamber (110) and second longitudinal chamber (120) are shown to be joined along a third flexible longitudinal seam (160) that is disposed between them and optionally extends laterally from their top surfaces. For example, the third flexible longitudinal seam may comprise a fabric bridge (e.g., rip-stop nylon, canvass, etc.) that may optionally but not necessarily be the same material as that which covers the top surfaces of the first longitudinal chamber and/or the second longitudinal chamber.

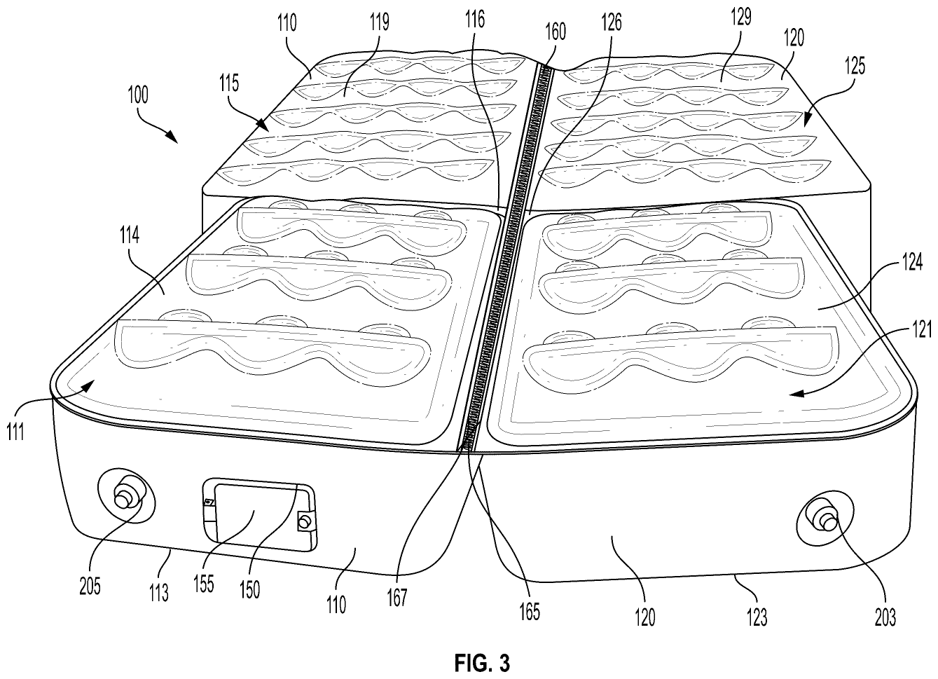

FIG. 3 depicts an inflatable mattress (100) according to another exemplary embodiment of the present invention. The inflatable mattress (100) may include a first longitudinal chamber (110) that includes a pump cavity (150) that receives and stores a removable air pump (obscured by cavity door (155) in the view of FIG. 3) that is operable to inflate the first longitudinal chamber in place, without being removed, through a first inlet (also obscured in the views of FIG. 3).

The inflatable mattress (100) may further include a second longitudinal chamber (120) that is independently inflatable or deflatable via a third inlet (203) disposed outside of the pump cavity (150), and that is configured to mate with the removable air pump outside of the pump cavity for optional inflation (if the user chooses to optionally utilize the second longitudinal chamber (120)). In the embodiment of FIG. 3, the first longitudinal chamber optionally further comprises an auxiliary inlet (205) to provide the option of inflating and deflating the first longitudinal chamber without use of the removable air pump within the pump cavity.

In certain embodiments, the inflatable mattress (100) may be sized to fit within a rear interior space of a sport utility vehicle. In such embodiments, each of the first longitudinal chamber (110) and the second longitudinal chamber (120) may preferably have a length in the range 65 to 80 inches, and a width in the range 40 to 60 inches. In certain embodiments, the width of the first longitudinal chamber optionally may be equal to the width of the second longitudinal chamber (e.g., 24 to 28 inches), as shown in FIG. 3. However, it is contemplated that in certain alternative embodiments, the width of the first longitudinal chamber may instead be greater than the width of the second longitudinal chamber by a width difference in the range of 10 to 14 inches. Such an alternative might be adopted, for example, to enable the first longitudinal chamber to be more comfortable than the second longitudinal chamber, in applications where it is expected that the second longitudinal chamber is to be substantially less frequently inflated and used.

In the exemplary embodiment of FIG. 3, the first longitudinal chamber (110) and the second longitudinal chamber (120) are shown to be joined along a third flexible longitudinal seam (160) that is disposed between them and optionally extends from their top surfaces. For example, the third flexible longitudinal seam may include a longitudinal zipper (165) that may be used to selectively join or separate the first longitudinal chamber and the second longitudinal chamber. As shown in FIG. 3, the longitudinal zipper may include a top cover (167) (e.g., a fabric flap to protect the longitudinal zipper from debris or to protect a mattress user from discomfort from direct contact with the longitudinal zipper).

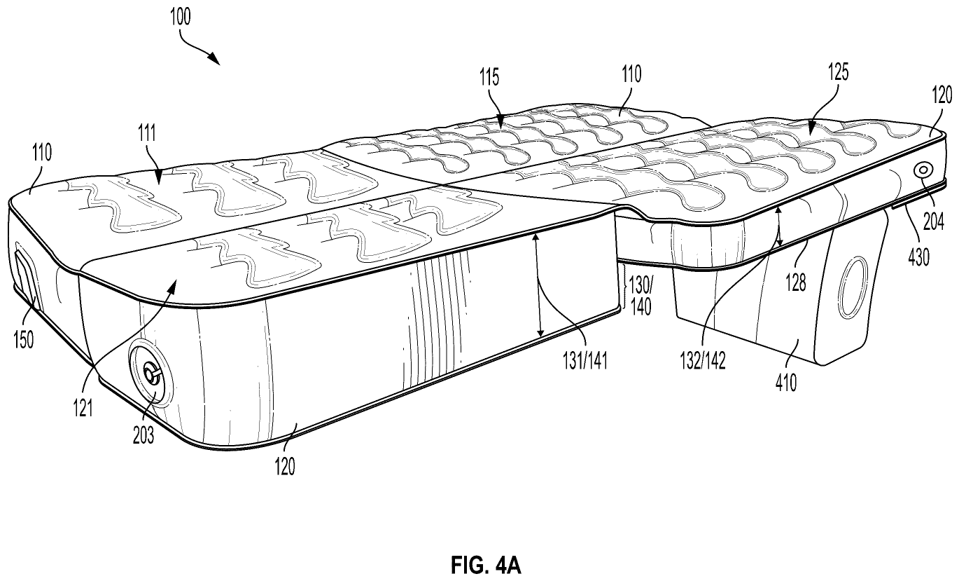

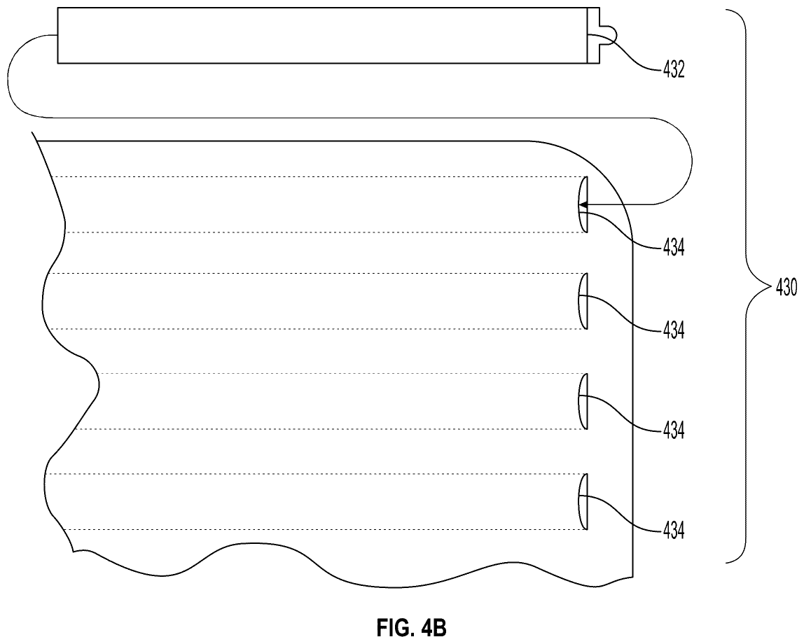

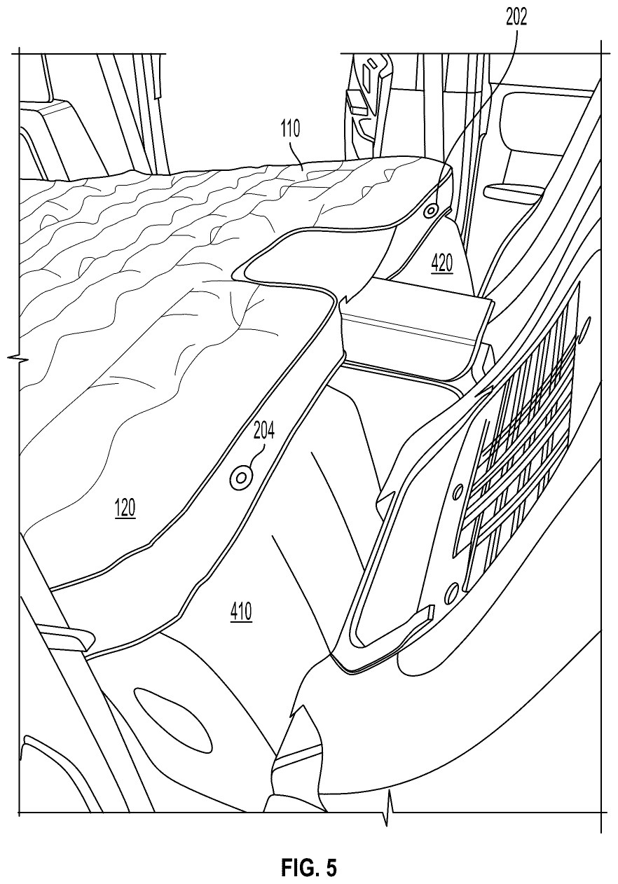

FIG. 4A depicts an inflatable mattress (100) according to another exemplary embodiment of the present invention. FIG. 4B is an underside view of a leading corner region of the inflatable mattress. FIG. 5 is a front perspective view of the forward portion of the inflatable mattress, shown as positioned within the interior space of a vehicle for usage context. FIG. 6 is a side perspective view of the forward portion of the inflatable mattress, shown as positioned within the interior space of a vehicle for usage context.

Now referring to FIGS. 4A to 6, the inflatable mattress (100) may include a first longitudinal chamber (110) that includes a pump cavity (150) that receives and stores a removable air pump that is selectively operable within the pump cavity. The inflatable mattress (100) may further include a second longitudinal chamber (120) that is independently inflatable or deflatable via a third inlet (203) disposed outside of the pump cavity.

In certain embodiments, the first longitudinal chamber (110) and the second longitudinal chamber (120) may be sized to fit within a rear interior space of a sport utility vehicle. For example, the rear interior space of certain sport utility vehicles may be partially defined by a bottom having unequal first and second heights, the first height being lower than and aft of the second height, and by a floor having a third height that is lower than and forward of both the first and second heights.

For such applications, the inflatable mattress (100) may have an understep—with the first longitudinal chamber (110) having a first understep (130) and the second longitudinal chamber (120) having a second understep (140) as shown in FIG. 4A-that laterally traverses the underside of the inflatable mattress. A first thickness (131) of the first longitudinal chamber (e.g., 8 to 12 inches) aft of the first understep may be greater than a second thickness (132) of the first longitudinal chamber (e.g., 3 to 6 inches) forward of the first understep. For example, in certain embodiments the first thickness may greater than the second thickness by a thickness difference in the range of 2 to 6 inches. Similarly, a third thickness (141) of the second longitudinal chamber (e.g., 8 to 12 inches) aft of the second understep may be greater than a fourth thickness (142) of the second longitudinal chamber (e.g., 3 to 6 inches) forward of the second understep. For example, in certain embodiments, the third thickness may be greater than the fourth thickness by a thickness difference in the range of 2 to 6 inches.

In certain embodiments, the inflatable mattress (100) may further include a first inflatable forward support (410) and/or a second inflatable forward support (420) that may be selectively inflatable independently from the first longitudinal chamber (110) and the second longitudinal chambers (120), for example via additional inlets disposed outside of the pump cavity (150). In certain embodiments, the first inflatable forward support and/or the second inflatable forward support are each preferably but not necessarily sized to extend vertically from the vehicle floor to abut the underside of the first longitudinal chamber and/or the second longitudinal chamber. In such embodiments the vertical thickness of the first inflatable forward support and/or the second inflatable forward support may be in the range 15 to 20 inches. The total vertical extent of the first inflatable forward support and/or the second inflatable forward support may be further adjusted by adjusting its amount of inflation during use.

In certain embodiments, each of the first inflatable forward support (410) and the second inflatable forward support (420) may be selectively attachable to a corresponding one of the first longitudinal chamber (110) and the second longitudinal chamber (120), for example by a conventional hook and loop interface. Alternatively, the first inflatable forward support and/or the second inflatable forward support may be permanently attached and inflated together with a corresponding one of the first longitudinal chamber and the second longitudinal chamber, e.g., via conventional internal ducts. In embodiments where the first inflatable forward support and/or the second inflatable forward support are not attached to or are detachable from the first longitudinal chamber and the second longitudinal chamber, the dimensions of each of the first inflatable forward support and/or the second inflatable forward support may be advantageously chosen so that their height in the vertical direction is appropriate for different vehicle applications depending upon orientation (e.g., height changes to a different desired height if rotated 90 degrees).

In certain alternative embodiments that may or may not include the first inflatable forward support (410) and/or the second inflatable forward support (420), the inflatable mattress (100) may include one or more underside-stiffened regions (430) (e.g., a forward region of the inflatable mattress (100)) to enable a cantilevered end portion of the inflatable mattress to support a user even where the environmental underlying support (e.g., from a supporting surface of the vehicle interior) is not directly beneath. For example, as shown in FIG. 4B, the underside-stiffened region may be a forward region of the inflatable mattress (e.g., a forward corner region) comprising one or more stiffening inserts (432) (e.g., comprising metal, plastic, or a composite material such as fiberglass or carbon fiber reinforced epoxy) that are slidably insertable and removable within one or more sewn fabric pockets (434) (e.g., optionally but not necessarily oriented longitudinally) in the underside of the inflatable mattress.

In certain embodiments, the underside-stiffened region (430) may not underly an entire width of the leading region of the inflatable mattress (100), but rather may be included only in the portion(s) of the leading region of the inflatable mattress that may expected to be cantilevered in particular vehicle interior applications. Limiting the length of the underside-stiffened region to less than ⅓^{rd} of the total length of the inflatable mattress, or providing removability by securing the stiffening inserts (432) to the inflatable mattress with tight but open-ended corresponding sewn fabric pockets (434) (e.g., sized to allow the stiffening inserts to be removable by sliding), may improve the subsequent foldability of the inflatable mattress when not in use according to certain embodiments.

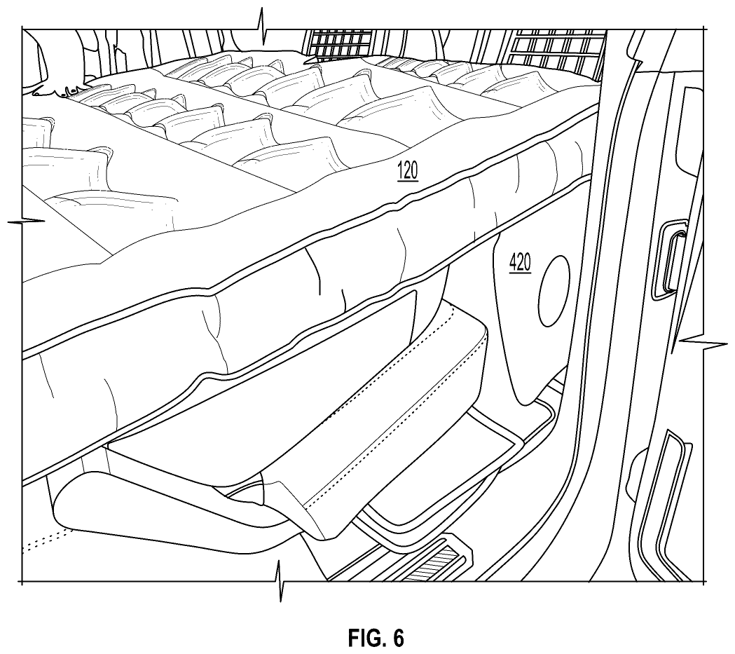

FIG. 7 depicts a first inflatable forward support (410) and a separate second inflatable forward support (420) of an inflatable mattress (100) according to another exemplary embodiment of the present invention, shown as positioned within the interior space of a vehicle, e.g., behind the vehicle's front seats, for usage context.

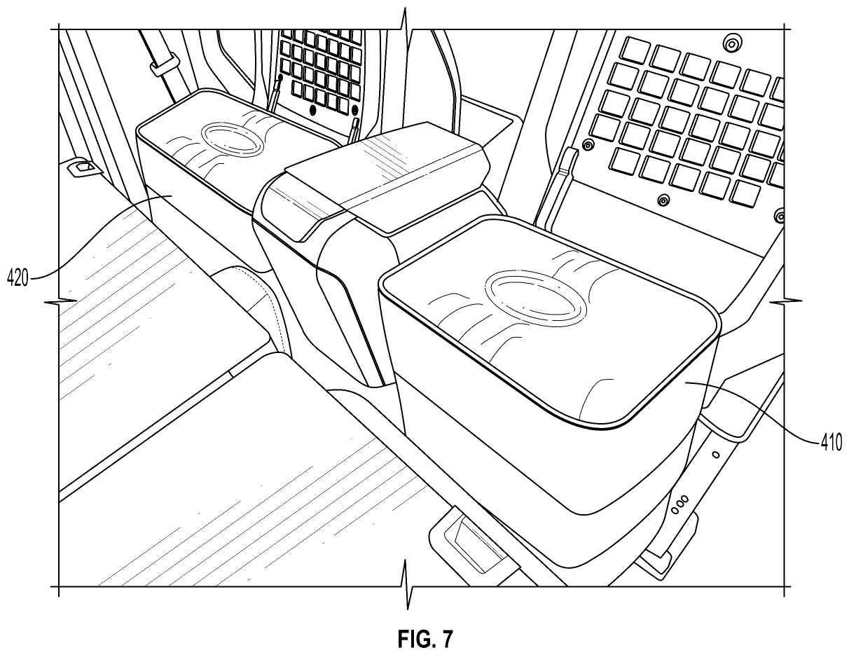

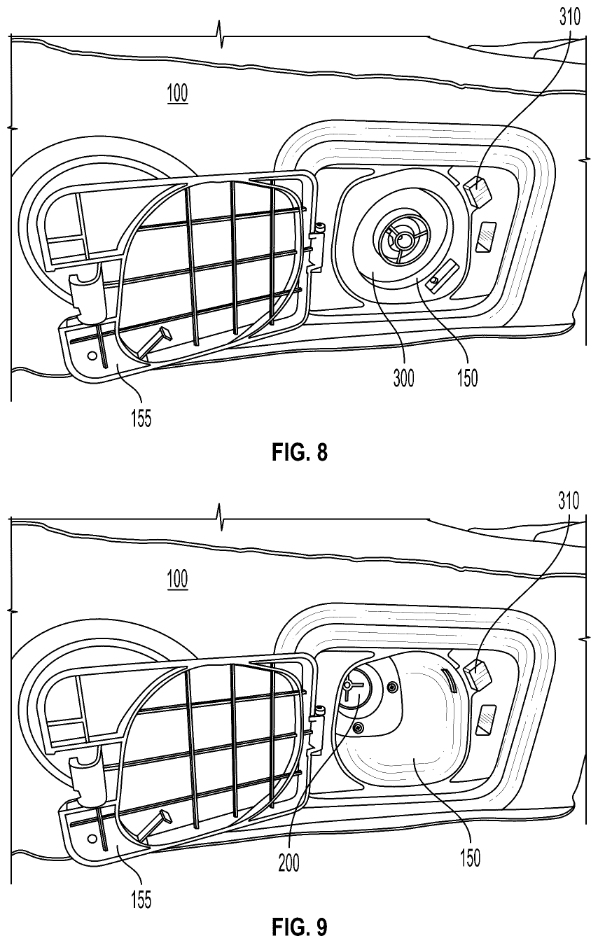

FIG. 8 depicts a removable air pump (300) within a pump cavity (150) of the aft end of an inflatable mattress (100), according to an exemplary embodiment of the present invention. FIG. 9 depicts the pump cavity with the removable air pump removed. The pump cavity is visible in FIGS. 8 and 9 because an optional cavity door (155) is shown in an open position; otherwise the pump cavity would be covered from view. It is contemplated herein that the cavity door optionally could be omitted entirely from the mattress design in certain alternative embodiments. Again, referring to the exemplary embodiment of FIGS. 8 and 9, the pump cavity preferably includes a first inlet (200) that is adapted to mate with an outlet of the removable air pump within the pump cavity for ready inflation (e.g., of a longitudinal chamber of the inflatable mattress) without removal of the removable air pump from the pump cavity.

The aft end of the inflatable mattress (100) may also optionally include an air pump ejection mechanism, for example including an air pump ejection button (310), that mechanically releases the removable air pump (300) from a conventional internal latch that otherwise prevents removal of the removable air pump. In the embodiment of FIGS. 8 and 9, the air pump ejection button is optionally disposed in a location where it is covered by the cavity door (155) when closed, for example to prevent accidental or unintended actuation of the air pump ejection button.

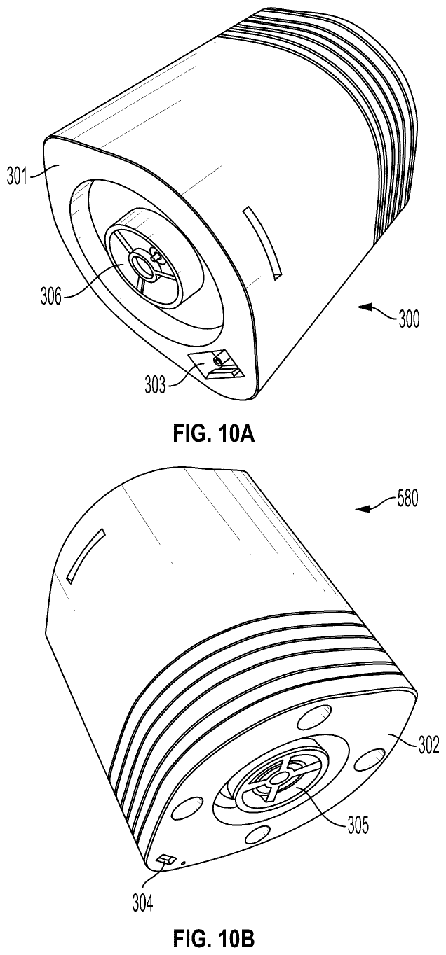

FIG. 10A depicts the removable air pump (300) according to an exemplary embodiment of the present invention, from a perspective from which its aft face (301) is visible. FIG. 10B is a perspective view of the insertable end (302) of the removable air pump (200). In the embodiment of FIGS. 10A and 10B, the aft face of the removable air pump optionally includes a pumping control switch (303), for example a conventional sliding or rocking switch to initiate, terminate, or reverse air pumping for inflation or deflation. The insertable end of the removable air pump is shown in FIG. 10B to optionally include a conventional charging port (304) for a conventional rechargeable battery (internal and not shown).

Now referring to FIGS. 8 to 10B, the removable air pump (300) preferably includes a pump outlet (305) that is located to mate with the first inlet (200) within the pump cavity (150) for inflation without removal of the removable air pump from the pump cavity. The removable air pump preferably also includes a pump inlet (306) to enable air to flow through the removable air pump during inflation operation. The roles of the pump outlet and pump inlet may be reversed if the pump is optionally used for deflation operation. The pump outlet is considered to “mate” with the first inlet if an outflow from the pump outlet is able to enter the first inlet within the pump cavity for mattress inflation.

In certain embodiments, the inflatable mattress (100) may include a conventional door switch that is actuated when the cavity door (155) is opened or closed. For example, such a door switch may be disposed within a hinge or latch of the cavity door, or may be actuated by a conventional plunger attached to the cavity door. In certain preferred embodiments, the door switch may be wired so that when the pumping control switch (303) is on, the removable air pump (300) will operate when the cavity door is open, but will turn off when the cavity door is closed and blocking air flow. In such embodiments, the pump cavity door switch may advantageously protect the removable air pump from futilely attempting to pump air through the cavity door when it is closed.

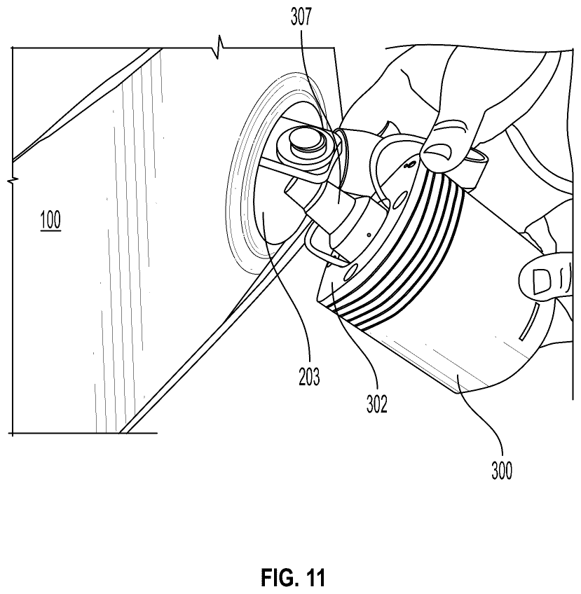

FIG. 11 depicts the optional use of the removable air pump (300) with a removable nozzle attachment (307), according to an exemplary embodiment of the present invention, to inflate a separately-inflatable mattress chamber like the second longitudinal chamber (120) of the inflatable mattress (100) of FIG. 3, via its third inlet (203).

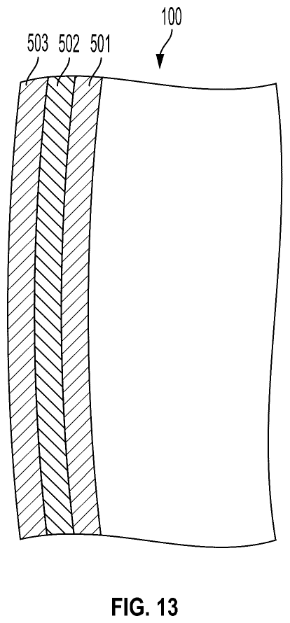

Any individual wall or combination of walls for the first longitudinal chamber (110) and or the second longitudinal chamber (120)-including, but not limited to, the first aft section lower wall (113), the first aft section upper wall (114), a first aft section sidewall, the first forward section lower wall (118), the first forward section upper wall (119), a first forward section sidewall, the second aft section lower wall (123), the second aft section upper wall (124), a second aft section sidewall, the second forward section lower wall (128), the second forward section upper wall (129), and/or a second forward section sidewall-may include multiple layers and/or multiple materials as shown in FIG. 13. One such example is a wall which comprises a first layer of material (501), a second layer of material (502), and a coating (503). The first layer of material may include a polymer material selected from the group consisting of polyvinyl chloride (PVC) and urethane film. The second layer of material may include a fabric material selected from the group consisting of polyester, wool, and cotton. The coating may be selected from the group consisting of a waterproofing, an ultraviolet protection coating, and combinations thereof.

In the foregoing specification, the invention is described with reference to specific exemplary embodiments thereof, but those skilled in the art will recognize that the invention is not limited thereto. It is contemplated that various features and aspects of the above-described invention may be used individually or jointly and possibly in an environment or application beyond those described herein. The specification and drawings are, accordingly, to be regarded as illustrative and exemplary rather than restrictive. The terms “comprising,” “including,” and “having,” as used herein are intended to be read as open-ended terms.

What is claimed is:

1. An inflatable mattress (100) for use in a vehicle, said inflatable mattress comprising:
a first longitudinal chamber (110) comprising:
a first chamber aft section (111) having a plurality of first collapsible columns (112) with each first collapsible column of the plurality of first collapsible columns being located between and connected to a first aft section lower wall (113) and a first aft section upper wall (114);
a first chamber forward section (115) connected to the first chamber aft section by a first flexible longitudinal seam (116) and having a plurality of second collapsible columns (117) with each second collapsible column of the plurality of second collapsible columns being located between and connected to a first forward section lower wall (118) and a first forward section upper wall (119); and
at least a first inlet (200) disposed in a first aft section wall.

2. The inflatable mattress of claim 1, wherein the first flexible longitudinal seam includes a fluid connection between the first chamber aft section and the first chamber forward section.

3. The inflatable mattress of claim 1, further comprising a second inlet (202) disposed in a first forward section wall.

4. The inflatable mattress of claim 1, wherein the first chamber aft section includes a pump cavity (150) configured to receive and store a removable air pump (300) with the first inlet located within the pump cavity.

5. The inflatable mattress of claim 1, wherein the first aft section lower wall and the first aft section upper wall each independently comprise a first layer of material (501), a second layer of material (502), and a coating (503).

6. The inflatable mattress of claim 5, wherein the first layer of material comprises a polymer material selected from the group consisting of polyvinyl chloride (PVC) and urethane film, the second layer of material comprises a fabric material selected from the group consisting of polyester, wool, and cotton, and the coating is selected from the group consisting of a waterproofing, an ultraviolet protection coating, and combinations thereof.

7. The inflatable mattress of claim 1, wherein the first chamber aft section comprises a first aft sidewall extending between the first aft section lower wall and the first aft section upper wall.

8. The inflatable mattress of claim 1, wherein the first forward section lower wall and the first forward section upper wall each independently comprise a first layer of material (501), a second layer of material (502), and a coating (503).

9. The inflatable mattress of claim 8, wherein the first layer of material comprises a polymer material selected from the group consisting of polyvinyl chloride (PVC) and urethane film, the second layer of material comprises a fabric material selected from the group consisting of polyester, wool, and cotton, and the coating is selected from the group consisting of a waterproofing, an ultraviolet protection coating, and combinations thereof.

10. The inflatable mattress of claim 1, wherein the first chamber forward section comprises a first forward sidewall extending between the first forward section lower wall and the first forward section upper wall.

11. The inflatable mattress of claim 1, further comprising:
a second longitudinal chamber (120) comprising:
a second chamber aft section (121) having a plurality of third collapsible columns (122) with each third collapsible column of the plurality of third collapsible columns being located between and connected to a second aft section lower wall (123) and a second aft section upper wall (124);
a second chamber forward section (125) connected to the second chamber aft section by a second flexible longitudinal seam (126) and having a plurality of fourth collapsible columns (127) with each fourth collapsible column of the plurality of fourth collapsible columns being located between and connected to a second forward section lower wall (128) and a second forward section upper wall (129); and
at least a third inlet (203) disposed in a second aft section wall; and
wherein the first chamber aft section is connected to the second chamber aft section by a third flexible longitudinal seam, and the first chamber forward section is connected to the second chamber forward section by a fourth flexible longitudinal seam.

12. The inflatable mattress of claim 11, wherein the second flexible longitudinal seam includes a fluid connection between the second chamber aft section and the second chamber forward section.

13. The inflatable mattress of claim 11, further comprising a fourth inlet (204) disposed in a second forward section wall.

14. The inflatable mattress of claim 11, wherein the second aft section lower wall and the second aft section upper wall each independently comprise a first layer of material (501), a second layer of material (502), and a coating (503).

15. The inflatable mattress of claim 14, wherein the first layer of material comprises a polymer material selected from the group consisting of polyvinyl chloride (PVC) and urethane film, the second layer of material comprises a fabric material selected from the group consisting of polyester, wool, and cotton, and the coating is selected from the group consisting of a waterproofing, an ultraviolet protection coating, and combinations thereof.

16. The inflatable mattress of claim 11, wherein the second chamber aft section comprises a second aft sidewall extending between the second aft section lower wall and the second aft section upper wall.

17. The inflatable mattress of claim 11, wherein the second forward section lower wall and the second forward section upper wall each independently comprise a first layer of material (501), a second layer of material (502), and a coating (503).

18. The inflatable mattress of claim 17, wherein the first layer of material comprises a polymer material selected from the group consisting of polyvinyl chloride (PVC) and urethane film, the second layer of material comprises a fabric material selected from the group consisting of polyester, wool, and cotton, and the coating is selected from the group consisting of a waterproofing, an ultraviolet protection coating, and combinations thereof.

19. The inflatable mattress of claim 11, wherein the second chamber forward section comprises a second forward sidewall extending between the second forward section lower wall and the second forward section upper wall.

20. The inflatable mattress of claim 11, further comprising:
a first understep (130) that laterally traverses a first underside of the first longitudinal chamber between the first chamber aft section and the first chamber forward section with a first thickness (131) of the first chamber aft section being greater than a second thickness (132) of the first chamber forward section; and
a second understep (140) that laterally traverses a second underside of the second longitudinal chamber between the second chamber aft section and the second chamber forward section with a third thickness (141) of the second chamber aft section being greater than a fourth thickness (142) of the second chamber forward section.
